(19) United States
(12) Patent Application Publication
(10) Pub. No.: US 2015/0357632 A1
(43) Pub. Date: Dec. 10, 2015

(54) NEGATIVE ELECTRODE ACTIVE MATERIAL FOR LITHIUM SECONDARY BATTERIES, AND LITHIUM SECONDARY BATTERY

(71) Applicant: HITACHI, LTD., Tokyo (JP)

(72) Inventors: Etsuko NISHIMURA, Tokyo (JP); Akihide TANAKA, Tokyo (JP); Katsunori NISHIMURA, Tokyo (JP); Shuichi SUZUKI, Tokyo (JP); Makoto OKAI, Tokyo (JP); Masao SHIMIZU, Tokyo (JP)

(73) Assignee: HITACHI, LTD., Tokyo (JP)

(21) Appl. No.: 14/763,320

(22) PCT Filed: Feb. 7, 2013
(86) PCT No.: PCT/JP2013/052854

§ 371 Date: Jul. 24, 2015

(51) Int. Cl. H01M 4/36; H01M 4/38; H01M 10/0525; H01M 4/587

(52) U.S. Cl. CPC H01M 4/364; H01M 4/587; H01M 4/366; H01M 4/381; H01M 10/0525; H01M 2004/027

(57) ABSTRACT

An object of the present invention is to provide a lithium secondary battery having a negative electrode having a novel structure in which the metal content is increased as compared to the past and the capacity density of the negative electrode is increased, and the lithium occlusion capacity of the metal is not decreased by repeated charge and discharge. In order to achieve this object, the negative electrode active material for a lithium secondary battery is characterized by being composed of a mixture of graphite particles capable of occluding and emitting lithium ions and particles containing metal, wherein the average particle diameter of the particles containing metal during discharge is 1/2000 to 1/10 of that of the graphite particles, the graphite particles have an average particle diameter during discharge of 2 μm to 20 μm, and addition ratio by weight of the particles containing metal is 10% to 50%.

### TECHNICAL FIELD

The present invention relates to a negative electrode active material for lithium secondary batteries, and a lithium secondary battery using the same.

### BACKGROUND ART

Lithium secondary batteries have high energy densities and therefore have attracted attention as batteries for electric vehicles and for electric power storage. Particularly, examples of the electric vehicles include a zero emission electric vehicle in which an engine is not mounted, a hybrid electric vehicle in which both an engine and a secondary battery are mounted, or a plug-in electric vehicle that is directly charged from a system power supply. Electric vehicles are desired to run a longer distance after charge and lithium secondary batteries with a higher capacity are desired.

In addition, lithium secondary batteries are also expected as a use for a stationary electric power storage system that stores power and supplies power at an emergency time when an electrical grid is blocked. Also regarding such large scale electric storage systems, a higher energy density of a battery makes it possible to provide a smaller system.

Moreover, for civil applications, electrical power usage of mobile devices such as cellular phones and smartphones is increasing and, therefore, capacity requirements for lithium secondary batteries have become very strong.

As such, in order to increase the energy density of a lithium secondary battery, materials of a positive electrode and a negative electrode are under active development, and representative prior art technologies relating to a negative electrode with a higher capacity include the following (PTL 1) to (PTL 6).

(PTL 1) discloses an invention relating to a negative electrode active material for a lithium secondary battery, including a core including crystalline carbon; a metal nano particle and an MOₓ (x is from 0.5 to 1.5, and M is Si, Sn, In, Al, or a combination thereof) nano particle disposed on a surface of the core; and a coating layer surrounding the surface of the core, the metal nano particle and the MOₓ (x is from 0.5 to 1.5, and M is Si, Sn, In, Al, or a combination thereof) nano particle, the coating layer including amorphous carbon.

(PTL 2) discloses a negative electrode active material for a lithium ion secondary battery, including a granulated substance obtained by subjecting a mixture of a metal powder capable of lithium ion occlusion and release and at least one graphite feed material selected from the group consisting of flake graphite and artificial graphite having a 0.335 nm or less (002)-face interplanar spacing to pulverization in high-velocity air current and granulation, wherein part of the graphite as the feed material is pulverized so as to have a structure of laminate of the graphite feed material and pulverizate thereof in which at the surface or interior thereof, a metal powder is dispersed.

(PTL 3) discloses an electrode material for a lithium secondary battery, characterized in that the electrode material includes 5 to 85% by mass of nanoscale silicon particles which have a BET surface area of from 5 to 700 m²/g and a mean primary particle diameter of from 5 to 200 nm, 0 to 10% by mass of conductive carbon black, 5 to 80% by mass of graphite having a mean particle diameter of from 1 μm to 100 μm, and 5 to 25% by mass of a binder, the proportions of the components summing to not more than 100% by mass.

(PTL 4) discloses a method for producing a negative electrode material for a lithium ion secondary battery including a composite particles, the method including: combining a first particle containing a carbonic substance A, a second particle containing silicon atom, and a carbonic substance precursor of a carbonic substance B different from the carbonic substance A; calcining the combined product yielded by the combining, to thereby obtain an aggregated product; and applying a shearing force to the aggregated product, to thereby obtain a composite particle having a volume average particle diameter from 1.0 times to 1.3 times the volume average particle diameter of the first particle, and containing the first particle and the second particle combined by the carbonic substance B.

(PTL 5) discloses a nonaqueous electrolyte secondary battery including′ a positive electrode, a negative electrode with a negative electrode mix layer containing a negative electrode active material and a binder formed on a negative electrode current collector; and a nonaqueous electrolyte, wherein the negative electrode active material contains a graphite powder where a lattice spacing d002 measured by an X-ray diffraction method is not larger than 0.337 nm, the size Lc of crystallite in the c-axis direction is not smaller than 30 nm, and 50% particle diameter (median diameter) D50 is within the range of 5 to 35 μm and a composite alloy powder containing tin, cobalt and carbon; the ratio of the composite alloy powder in the negative electrode active material is 3 to 20% by mass; and the void ratio of the negative electrode mix layer is within the range of 15 to 40%.

(PTL 6) discloses a negative electrode active material including complex material particles including silicon and graphite, a carbon layer covering a surface of the complex material particles, and a silicon-metal alloy formed between the interfaces of the complex material and the carbon layer.

### CITATION LIST

### Patent Literature

PTL 1: JP 2012-99452 A

PTL 2: JP 2008-27897 A

PTL 3: JP 2007-534118 T

PTL 4: JP 2012-124121 A

PTL 5: JP 2009-245940 A

PTL 6: JP 2007-67956 A

### SUMMARY OF INVENTION

### Technical Problem

An object of the present invention is to provide a negative electrode having a novel structure in which the metal content is increased as compared to the past and the capacity density of the negative electrode is increased, and the lithium occlusion capacity of the metal is not decreased by repeated charge and discharge, and a lithium secondary battery having the same.

### Solution to Problem

As a result to earnest studies, the present inventors have accomplished an invention by finding that a mixture of graphite particles capable of occluding and emitting lithium ions and particles containing metal is used as a negative electrode active material and the average particle diameters and so on of the graphite particles and the particles containing metal are controlled to fall within prescribed ranges, so that the graphite particles hold the structure of the entire negative electrode and the particles containing metal mainly increase the capacity of the negative electrode, whereby there can be obtained a lithium secondary battery having an initial charge/discharge capacity larger than the capacity of graphite (372 mAh/g) and being less prone to allow the capacity of the negative electrode to be decreased by a cycle of charge and discharge.

That is, the negative electrode active material for a lithium secondary battery of the present invention is characterized by being composed of a mixture of graphite particles capable Of occluding and emitting lithium ions and particles containing metal, wherein the average particle diameter of the particles containing metal during discharge is 1/2000 to 1/10 of that of the graphite particles, the graphite particles have an average particle diameter during discharge of 2 μm to 20 μm, and the addition ratio by weight of the particles containing metal is 10% to 50%.

### Advantageous Effects of Invention

According to the present invention, a lithium secondary battery can be increased in initial capacity and improved in cycle lifetime. Problems, configurations, and effects other than those described above will be elucidated in the following description of embodiments.

### BRIEF DESCRIPTION OF DRAWINGS

FIG. 1 is a diagram showing a cross-sectional structure of one embodiment of the lithium secondary battery according to the present invention.

FIG. 2A is a diagram schematically showing a cross-sectional structure of a negative electrode in the present invention.

FIG. 2B is a diagram schematically showing a cross-sectional structure of a conventional negative electrode.

FIG. 3 is a diagram showing a battery module using the lithium secondary battery according to the present invention.

FIG. 4 is a diagram showing a battery system using the lithium secondary battery according to the present invention.

### DESCRIPTION OF EMBODIMENTS

Hereafter, the present invention is described in detail on the basis of drawings.

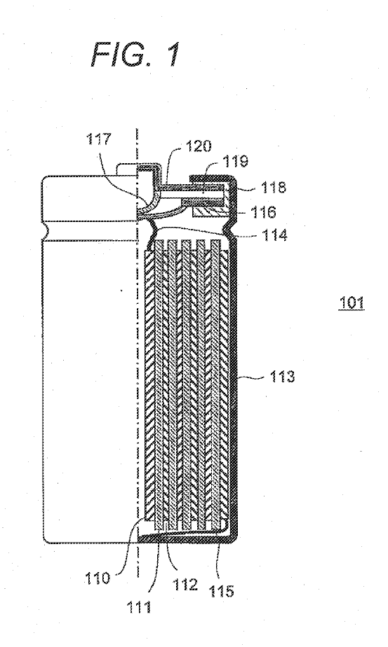

FIG. 1 schematically shows an internal structure of one embodiment of the lithium secondary battery according to the present invention. The lithium secondary battery as referred to herein is an electrochemical device that makes it possible to store or use electric energy by occluding and emitting lithium ions to and from an electrode in a nonaqueous electrolyte.

The lithium secondary battery 101 of FIG. 1 includes a positive electrode 110, a separator 111, a negative electrode 112, a battery can 113, a positive electrode current collection tab 114, a negative electrode current collection tab 115, an inner lid 116, an internal pressure release valve 117, a gasket 118, a positive temperature coefficient (PTC; Positive temperature coefficient) resistive element 119, and a battery lid 120 that serves also as a positive electrode external terminal. The battery lid 120 is an integral component made up of the inner lid. 116, the internal pressure release valve 117, the gasket 118, and the positive temperature coefficient (PTC) resistive element 119. For attaching the battery lid 120 to the battery can 113, not only caulking but also other methods such as welding and adhering can be used.

Although the battery can 113, which is the container of the lithium secondary battery of FIG. 1, is of a type with a, bottom, it is also possible to use a cylindrical container having no bottom, attach the battery lid 120 of FIG. 1 to the bottom, and use them with a negative electrode attached to the battery lid 120. Even when a battery case having an arbitrary shape is used in accordance with a terminal attaching method, the effect of the invention, is not affected.

The positive electrode 110 is mainly composed of a positive electrode active material, a conductive agent, a binder, and a current collector. Examples of the positive electrode active material include LiCoO₂, LiNIO₂, and LiMn₂O₄. Additional examples include LiMnO₃, LIMn₂O₃, LiMnO₂, Li₄Mn₅O₁₂, LiMn₂₋ₓMₓO₂ (M=Co, Ni, Fe, Cr, Zn, or Ta, and x=0.01 to 0.2), Li₂Mn₃MO₈ (M=Fe, Co, Ni, Cu, or Zn), Li₁₋ₓAₓMn₂O₄ (A=Mg, B, Al, Fe, Cc, Ni, Cr, Zn, or Ca, and x=0.01 to 0.1), LiNi₁₋ₓMₓO₂ (M=Co, Fe, or Ga, and x=0.01 to 0.2), LiFeO₂, Fe₂(SO₄)₃, LiCo₁₋ₓMₓO₂ (M=Ni, Fe, or Mn, and x=0.01 to 0.2), LiNi₁₋ₓMₓO₂, (M=Mn, Fe, Co, Al, Ga, Ca, or Mg, and x=0.01 to 0.2), Fe(MoO₄)₃, FeF₃, LiFePO₄, and LiMnPO₄. It is noted that the positive electrode active material is not limited to these materials because the present invention is not restricted with respect to a positive electrode material.

The particle diameter of the positive electrode active material is defined to be equal to or less than the thickness of a mixture layer. In the case where coarse particles having a size that is equal to or larger than the thickness of the mixture layer are present in the positive electrode active material powder, the coarse particles are removed in advance using sieve classification, air classification, or the like, and thus particles that are equal to or less than the thickness of the mixture layer are prepared.

Since positive electrode active materials are oxides and are high in electric resistance, there is utilized a conductive agent composed of a carbon powder for compensating their electrical conductivity. As the conductive agent, a carbon material, such as acetylene black, carbon black, graphite, and amorphous carbon, can be used. In order to form an electronic network within the positive electrode, the particle diameter of the conductive agent is smaller than the average particle diameter of the positive electrode active material and it is desirable to adjust the particle diameter to up to 1/10 the average particle diameter.

Since both the positive electrode active material and the conductive agent are powders, a binder is mixed with these powders to bind the powders and at the same time adhere them to a current collector, thereby producing a positive electrode.

As the current collector, aluminum foil having a thickness of 10 μm to 100 μm, aluminum punched foil having a thickness of 10 μm to 100 μm and a hole diameter of 0.11 mm to 10 mm, an expanded metal, a foamed metal plate, or the like may be used. In addition to aluminum, stainless steel, titanium, or the like may be applied as the material of the current collector. In the present invention, any material that does not exhibit any change such as dissolution and oxidation during the use of a battery can be used for the current collector with no restrictions regarding material, shape, production method, etc.

In order to produce the positive electrode 110, it is necessary to prepare a positive electrode slurry. While an exemplary composition thereof contains 89 parts by weight of a positive electrode active material, 4 parts by weight of acetylene black, and 7 parts by weight of a PVDF (polyfluorovinylidene) hinder, the composition is varied depending upon the type, the specific surface area, the particle size distribution, and so on of the material and the composition is not limited to the exemplary composition.

As the solvent of the Positive electrode slurry, any solvent capable of dissolving the binder can be used. For example, when PVDF is used as the binder, N-methyl-2-pyrrolidone is often used. The solvent is chosen depending upon the type of the hinder. For the dispersion treatment of the positive electrode material, a publicly known kneading machine or dispersion machine is used.

A positive electrode slurry prepared by mixing a positive electrode active material, a conductive agent, a binder, and an organic solvent is made to attached to the current collector by a doctor blade method, a dipping method, a spraying method, or the like. Then, the organic solvent is dried and the positive electrode is pressure-molded with a roll press. Thus, a positive electrode can be produced. A plurality of mixture layers may be laminated on the current collector by performing the operation from the application to the drying twice or more.

The negative electrode 112 is composed of a negative electrode active material, a binder, and a current collector. The negative electrode active material is a mixture of graphite particles capable of occluding and emitting lithium ions and particles containing metal.

Although the graphite particles may be pure graphite, graphite particles in which a coating layer made of a low crystalline carbonaceous material is formed on the surface of a core made of graphite, namely, graphite particles having a core/shell structure can be used in order to inhibit the reductive decomposition of an electrolytic solution.

The distance of the plane index (002) of a graphite crystal determined by wide angle X-ray diffractometry (the distance is indicated by d₀₀₂) is desirably within the range of from 0.3345 nm to 0.3370 nm. This is because if the distance is within this range, the occlusion amount of lithium ions at a low negative electrode potential is large and the energy (Wh) of a battery increases. The a axis length (henceforth referred to as Lc) of a graphite crystal is preferably, but is not limited to, within the range of from 20 nm to 90 nm.

Next, a description is made to a method for producing a coating layer to be formed on the surface of a core. Although the coating layer is made of a carbonaceous material, it may contain a small amount of nitrogen, phosphorus, oxygen, an alkali metal, an alkaline earth metal, a transition metal, etc. If the coating layer can allow lithium ions to penetrate, the effect of the present invention can be obtained.

The thickness of the coating layer is desirably 5 nm to 200 nm. If the coating layer is excessively thin, an electrolytic solution will permeate and reductive decomposition of the electrolytic solution will occur on the surface of the core. Conversely, if the coating layer is excessively thick, the diffusion of lithium ions will be disturbed and a decrease in the capacity at a large current will be induced.

As the coating layer, a coating layer containing carbon as the main ingredient is preferred and is the most suitable for the present invention. Desirably, the coating layer containing carbon as the main ingredient has a dense structure rather than porous. This is because if an increased number of minute pores are formed in the coating layer, the solvent in the electrolytic solution will permeate into the coating layer and reductive decomposition will be induced on the surface of the core.

A coating layer made of carbon can be formed in the following procedures, for example. A carbon core-phenol resin mixed solution is first prepared by immersing and dispersing a carbon core in a methanol solution of a novolac type phenol resin, and then, the solution is subjected to filtration, drying, and heat treatment within a range of 200° C. to 1000° C. successively, whereby graphite particles in which the surface of the core is coated with carbon can be obtained. Especially, it is preferable to adjust the temperature range of the heat treatment to 500° C. to 800° C. because the bulk modulus of the coating layer becomes smaller than the bulk modulus of the core. It is also permitted to use a polycyclic aromatic compound such as naphthalene, anthracene, and creosote oil, instead of the phenol resin.

It is also possible to form the coating layer made of carbon by another method different from the method described above. For example, a method of coating the core with polyvinyl alcohol, followed by heat decomposition is available. In this case, the heat treatment temperature may be adjusted to within the range of 200° C. to 400° C. Especially, it is desirable to adjust the heat treatment temperature to 300° C. to 400° C. because the coating layer made of carbon is firmly jointed to the core.

Moreover, it is also possible as an alternative method to treat with an oxygen-containing organic compound, such as polyvinyl chloride and polyvinylpyrrolidone. These compounds are mixed with graphite cores and then heated to a temperature at which the compounds are thermally decomposed, so that a carbon coating layer is formed.

The thickness of the coating layer can be controlled by increasing or decreasing the addition amount of the carbon source, such as the aforementioned phenol resin and the poly(vinyl alcohol), relative to the weight of the cores or by adjusting the heat treatment conditions.

The surface condition of graphite particles having such a core-shell structure can be analyzed from a Raman peak that shows the crystallinity of graphite on the surface in the present invention, the ratio I₁₃₆₀/I₁₅₈₀ of the peak intensity of a 1360 cm⁻¹ region (D band) to that of a 1580 cm⁻¹ region (G band) is preferably within the range of 0.1 to 0.6. The G band becomes more intense as the crystallinity of the coating layer becomes higher (as the coating layer approaches a crystal of graphite), and the D band becomes more intense as the coating layer approaches amorphous. Therefore, the ratio of the peak intensities serves as an index that indicates the degree of amorphism. The Raman peak intensity ratios of the graphite particles having a core-shell structure used in the examples described infra were within the range of 0.3 to 0.5. In the present invention, however, the Raman peak intensity ratio is not limited to this. When graphite articles made of only cores having no coating are used, only a G band peak is observed.

The average particle diameter of the graphite particles is not smaller than 2 μm and not larger than 20 μm. In the present invention, the average particle diameter defined for either the graphite particles or the metal-Containing particles described infra means D₅₀, namely, a particle diameter at which the cumulative volume of particles becomes 50% of the whole particles (median diameter) The average particle diameter is measured with a publicly known particle size distribution analyzer using a laser scattering method. In the present invention, the measurement of an average particle diameter uses a value during discharge for the convenience of measurement. The term “during discharge” as used herein not only means a state where a lithium secondary battery was produced using a negative electrode active material and the battery was charged and has been discharged, but also means a negative electrode active material in a state where it is not yet included in a lithium secondary battery (since the operation just after the production of a lithium secondary battery is always a charging operation, a negative electrode active material before being included in a battery always corresponds to a discharged state) Although the particle Size distribution of each of the metal-containing particles and the graphite particles in a charged state can be measured, it is difficult in some cases to select a solvent for particle size measurement. Then, a long-lifetime negative electrode was obtained by selecting metal-containing particles on the basis of the average particle diameter of the powder in a discharged state and thereby satisfying the average particle diameter ratio defined in the present invention. Accordingly, in the present invention, the average particle diameter of particles in a discharged state is used. When the graphite particles are particles having a core-shell structure having a coating layer, the average particle diameter of the graphite particles defined, in the present invention shall mean the average particle diameter of the cores.

Although the kind of the metal that constitutes the particles containing metal to be mixed with the graphite particles is not particularly limited, silicon is preferably used. Besides silicon, tin, magnesium, aluminum, or the like, or their alloy or their oxides can be used.

The average particle diameter during discharge of the particles containing metal is 1/2000 to 1/10, preferably 1/200 to 1/10, of that of the graphite particles. The addition ratio of the particles containing metal in the negative electrode active material needs to be 10% to 50% in weight ratio.

Preferably, the weight ratio of the metal in the particles containing metal is 60% to 100%.

Preferably, one or more elements selected from the group consisting of carbon, nitrogen, oxygen, iron, nickel, cobalt, manganese, and titanium are contained in the surface of the particles containing metal. Carbon may be contained in the form of a metal carbide. These elements may be contained in the internal part of a metal-containing particle in addition to the surface of the metal-containing particle. Such an element prevents direct contact of a particle containing metal with an electrolytic solution and inhibits a decomposition reaction of the electrolytic solution, developing a function to prevent the capacity of a negative electrode from lowering.

As a method for obtaining the aforementioned metal-containing particles, for example, a silicon-nitrogen coating film can be formed on a metal surface by heat-treating metal particles in a nitrogen gas atmosphere. Alternatively, the metal-containing particles may be produced by pulverizing coarse grains of a metal nitride with a ball mill or the like.

Besides, carbon or oxygen can be formed on the surface of metal particles with a chemical vapor deposition (Chemical Vapor Deposition) device. Alternatively, an oxide layer can be formed on a surface by leaving metal particles in the air.

By adding iron, nickel, cobalt, manganese, or titanium to a metal and thereby forming an alloy, there can be obtained metal-containing particles on the surface of which an inactive metal layer such as iron has been formed. For the production of an alloy, a mechanical fusion device can be used. Alternatively, use of a vapor deposition device makes it possible to fix an element, such as iron, only on the surface of metal particles.

As necessary, the negative electrode active material is allowed to further include carbon fibers having a length up to twice the average particle diameter of the graphite particles. Preferably, the amount of the carbon fibers is 1% by weight to 5% by weight of the entire weight of the negative electrode active Material (composed of graphite particles, metal-containing particles, and carbon fibers).

The negative electrode active material may further contain carbon nanotubes and/or carbon black. Preferably, the amount of the carbon nanotubes and/or the carbon black is adjusted to 1% by weight to 2% by weight of the entire weight of the negative electrode active material (composed of graphite particles, metal-containing particles, and carbon nanotubes and/or carbon black).

As the negative electrode current collector, copper foil having a thickness of 10 μm to 100 μm, punched copper foil having a thickness of 10 μm to 100 μm and a hole diameter of 0.1 mm to 10 mm, expanded metal, a foamed metal plate, or the like may be used. In addition to copper, stainless steel, titanium, nickel, or the like ma e applied as the material of the current collector. In this invention, any current collector may be used without restrictions with respect to the material, the shape, the manufacturing method, and so on.

A negative electrode slurry prepared by mixing a negative electrode active material, a binder, and an organic solvent is made to be attached to the current collector by a doctor blade method, a dipping method, a spraying method, or the like. Then, the Organic solvent, is dried and then the negative electrode is pressure-molded with a roll press. Thus, a negative electrode can be produced. A plurality of mixture layers may be laminated on the current collector by performing the operation from the application to the drying twice or more.

Hereafter, a description is made to the procedure of the production of the lithium secondary battery 101 depicted in FIG. 1. A separator 111 is inserted to between the positive electrode 110 and the negative electrode 112 prepared by the above-described methods, thereby preventing short circuit between the positive electrode 110 and the negative electrode 112. As the separator Ill, there can be used a polyolefin-based polymer sheet made of polyethylene, polypropylene or the like or a separator having a multilayer structure in which a polyolefin-based polymer and a fluorine-based polymer sheet typified by polyethylene tetrafluoride are welded. A mixture of a ceramics and a binder may be formed into a thin layer on the surface of the separator 111 so as to prevent the separator 111 from shrinking when the battery temperature has been raised. Since such a separator 111 has to allow lithium ions to pass therethrough during charge and discharge of the battery, it is generally preferable for the separator to have a pore size of 0.01 μm to 10 μm and a porosity of 20% to 90%.

The separator 111 is inserted to between an electrode disposed at the end of the electrode group and the battery can 113 as well so as to prevent short circuit between the positive electrode 110 and the negative electrode 112 via the battery can 113. The surfaces Of the separator 111, the positive electrode 110, and the negative electrode 112 as well as the inside of the pores hold an electrolytic solution composed of an electrolyte and a nonaqueous solvent.

The electrode group and the upper part of the separator laminate are electrically connected to an external terminal via a lead. The positive electrode 110 is connected to the inner lid 116 via the positive electrode current collection tab 114. The negative electrode 112 is connected to the battery can 113 via the negative electrode current collection tab 115. The positive electrode current collection tab 114 and the negative electrode current collection tab 115 may have any shape, such as a wire shape and a tabular shape. The positive electrode current collection tab 114 and the negative electrode current collection tab 115 may have any shape or may be made of any material according to the structure of the battery can 113 as long as they are configured to achieve a small ohmic loss when a current flows therethrough and are made of a material that does not react with the electrolytic solution.

A positive temperature coefficient (PTO) resistance element. 119 is used for stopping charge and discharge of the lithium secondary battery 101 and to protect the battery when the temperature inside the battery has increased.

The electrode group may be configured in various forms such as in a wound structure shown in FIG. 1 as well as in a form wound into any Shape including a flattened shape, in a strip shape, etc. The shape of the battery case may be selected depending upon the shape of the electrode group, such as a cylindrical shape, a flattened ellipse shape, and a rectangular shape.

The material of the battery can 113 is selected from among materials anti-corrosive to the nonaqueous electrolytic solution, such as aluminum, stainless steel, and nickel-plated steel. When the battery can 113 is electrically connected to the positive electrode current collection tab 114 or the negative electrode current collection tab 115, the material of the leads is selected so as not to alter the quality of the material at a part in contact with the nonaqueous electrolytic solution due to corrosion of the battery case or alloying with lithium ions.

Then, the battery lid 120 is brought into intimate contact with the battery can 113, thereby sealing the entire battery. In the following Examples, a battery lid 120 was attached to a battery can 113 by caulking. Besides, when a battery is sealed, publicly known technologies such as welding and adhering may be applied.

Representative examples of an electrolytic solution usable for the present invention include a solution prepared by mixing dimethyl carbonate, diethyl carbonate, ethyl methyl carbonate, or the like with ethylene carbonate and then dissolving lithium hexafluorophosphate (LiPF₆) or lithium tetrafluoroborate (LiBF₄) as an electrolyte in the resulting mixed solvent. The present invention may use other electrolytic solutions having other compositions without being limited to the type of the solvent or the electrolyte, and the mixing ratio of the solvents. The electrolyte may also be used in a state of being contained in an ion conductive polymer such as polyvinylidene fluoride, polyacrylonitrile, polyethylene oxide, and polymethyl methacrylate. In this case, the separator is not necessary. Alternatively, a mixture (gel electrolyte) composed of polyvinylidene fluoride or the like and a nonaqueous electrolyte may also be used.

Examples of the solvent that can be used for the electrolytic solution include nonaqueous solvents such as propylene carbonate, ethylene carbonate, butylene carbonate, vinylene carbonate, γ-butylolaCtone, dimethyl carbonate, diethyl carbonate, methyl ethyl carbonate, 1,2-dimetoxy ethane, 2-methyltetrahydrofuran, dimethyl sulfoxide, 1,3-dioxolane formamide, dimethyl formamide, methyl propionate, ethyl propionate, triesters of phosphoric acid, trimethoxymethane, dioxolane, diethyl ether, sulfolane, 3-methyl-2-oxazolidinone, tetrahydrofuran, 1,2-diethoxyethane, chloroethylene carbonate, and chloropropylene carbonate. Other solvents may be used as long as these solvents are not decomposed on the positive electrode or the negative electrode embedded in the lithium secondary battery of the present invention.

Examples of the electrolyte include various types of lithium salts such as imide salts of lithium represented by LiPF₆, LiBF₄, LiClO₄, LiCF₃SO₃, LiCF₃CO₂, LiAsF₆, LiSbF₆, in chemical formula, or lithium trifluoromethanesulfonimide. A nonaqueous electrolytic solution that is obtained by dissolving such a salt in the above-described solvent may be used as the electrolytic solution for the lithium secondary battery. Other electrolytes may be used as long as these solvents are not decomposed on the positive electrode or the negative electrode embedded in the lithium secondary battery of the present invention.

Moreover, an ionic liquid may be used as necessary. For example, from among 1-ethyl-3-methylimidazolium tetrafluoroborate (EMI-BF₄), a mixed complex of a lithium salt LiN(SO₂CF₃)₂ (LiTFSI), triglyme and tetraglyme, cyclic quaternary ammonium cations (e.g., N-methyl-N-propylpyrrolidinium), and imide anions (e.g., bis(fluorosulfonyl)imide), a combination that is decomposed at neither a positive electrode nor a negative electrode is chosen and can be used for the lithium secondary battery of the present invention.

The method for injecting the electrolytic solution may be a method in which a battery lid 120 is removed from a battery can 113 and then the electrolytic solution is added directly to electrodes or a method in which the electrolytic solution is added through an injection port provided in a battery lid 120.

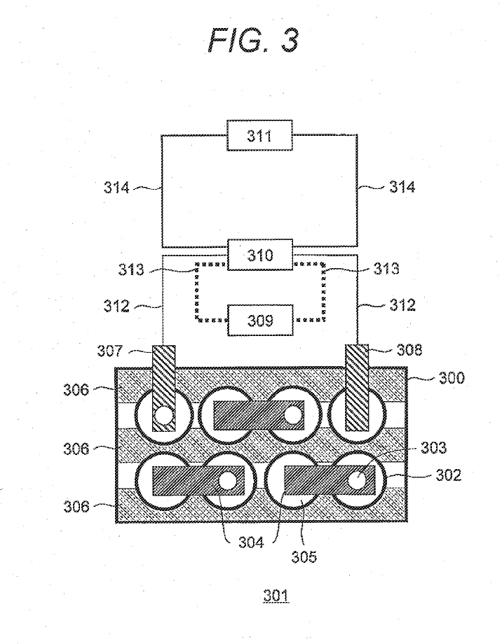

Then, a battery module (battery pack) using the lithium secondary battery of the present invention is described on the basis of FIG. 3. FIG. 3 shows one embodiment of a battery module, wherein eight cylindrical lithium secondary batteries of FIG. 1 are connected in series, constituting a battery module (battery pack) This battery module 301 is constituted mainly of a lithium secondary battery 302, which is a single battery, a positive electrode terminal 303, a bus bar 304, a battery can 305, a hold component 306, a charge and discharge circuit 310, a calculation unit 309, an external power source 311, a power line 312, a signal line 313, a positive electrode external terminal 307, a negative electrode external terminal 308, and an external power cable 314.

The external power source 311 can be replaced by an electric supplying and loading device that has both functions of supply and consumption of electric power when, for example, test for confirming the efficacy of a battery module is performed. An external load may be provided instead of the external power source 311. The external power source 311 or the external load may be chosen appropriately according to the type of usage of an electric vehicle, such as an electric vehicle, a machine tool, or a distributed, electric power storage system, a backup power supply system, etc., and it does not induce any difference with the effect of the present invention.

The lithium secondary battery of the present invention and a battery module using the same can be used for a consumer product, such as a portable electronic device, a cellular phone, and a power tools, a power source of an electric vehicle, a train, a storage battery for renewable energy, a crewless transfer car, care equipment, etc. Furthermore, the lithium secondary battery of the invention, is applicable as a power source of a logistic train for search of the Moon, the Mars, or the like. The lithium secondary battery of the invention can be used for various types of power sources for air conditioning, temperature control, purification of sewage or air, driving power, etc. in a space suit, a space station, a building or a living space (regardless of a closed state or an opened state) on the earth or other celestial bodies, a spacecraft for interplanetary movement, a planetary land rover, a closed space in water or sea, a submarine, a fish observing facility, and the like.

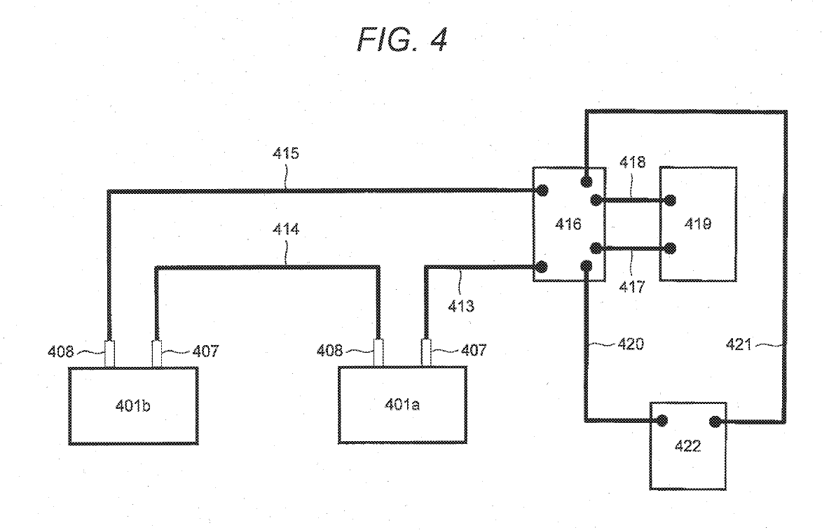

Next, a battery system using the lithium secondary battery of the present invention is described on the basis of FIG. 4. FIG. 4 shows one embodiment of a battery system, and this system is equipped with two battery modules using the lithium secondary batteries described above.

In FIG. 4, battery modules 401a and 401b are connected in series. The negative electrode external terminal 407 of the battery module 401a is connected to the negative electrode input terminal of a charge/discharge controller 416 via a power cable 413. The positive electrode external terminal 408 of the battery module 401a is connected to the negative electrode external terminal 407 of the battery module 401h via a power cable 414. The positive electrode external terminal 408 of the battery module 401b is connected to the positive electrode input terminal of a charge/discharge controller 416 via a power cable 415. Such a wiring configuration makes it possible to charge or discharge the two battery modules 401a and 401b.

The charge/discharge controller 416 delivers and receives electric power to and from an external device 419 via power cables 417 and 418, respectively. The external device 419 includes various types of electric instruments for feeding power to the charge/discharge controller 416, such as an external power source and a regenerative motor, as well as an inverter, a converter, and a load to which this system supplies power. The inverter and the like may be provided depending on whether the external device 419 works on AC or DC. As these instruments, publicly known types may be applied arbitrarily.

In FIG. 4, a power generator 422 imitating the operating conditions of a wind power generator is installed as an instrument that produces renewable energy, and it is connected to the charge/discharge controller 416 via power cables 420 and 421. When the power generator 422 generates electricity, the charge/discharge controller 416 shifts to a charging mode so as to supply power to the external device 419 and also charge the battery modules 401a and 402b with excess power. When the power generator imitating a wind power generator generates power in an amount less than the electric power required by the external device 419, the charge/discharge controller 416 works so as to allow the battery modules 401a and 401b to discharge. Incidentally, the power generator 422 may be replaced by any other devices such as a solar cell, a geothermal generator; a fuel cell, and a gas turbine generator. It is also permitted to make the charge/discharge controller 416 memorize an automatic operation program so as to undergo the above-described operation.

The battery modules 401a and 401b are subjected to ordinary charge by which a rated capacity is obtained. For example, constant-voltage charge of 4.2 V may be executed at a charge current of 1 hour rate for 0.5 hour. Since the charge conditions may be decided according to design such as the types and the usage amounts of the materials of a lithium secondary battery, optimum conditions are set for the specifications of the battery.

After charging the battery modules 401a and 401b, the charge/discharge controller 416 is switched to a discharge mode, so as to let the batteries discharge. Usually, discharge is stopped when they have reached a constant lower limit voltage.

The number of the battery modules, the number of series connections, and the number of parallel connections of FIG. 4 are not particularly limited and the number of series connections or the number of, parallel connections may be increased or decreased depending upon the amount of electricity needed by users.

### Examples

Next, the present invention will be described in more detail on the basis of examples and comparative examples.

### Examples 1 and 17 and Comparative Examples 1 to 2

In the following Examples and Comparative Examples, LiNi_{1/3}Co_{1/3}Mn_{1/3}O₂ was used as the positive electrode active material in the lithium secondary batteries produced. As to the composition of a positive electrode mixture, acetylene black and PVDF were used, and the positive electrode active material, acetylene black, and PVDF were mixed in order in a weight ratio of 89:4:7 to prepare a positive electrode slurry, which was then applied to a current collector and was dried to prepare a positive electrode.

In the following Examples and Comparative Examples, as graphite particles to be used as a negative electrode active material, there were used particles having a core-shell structure in which a carbonaceous coating layer was formed on a graphite core. In the preparation of the core made of graphite, 50 parts by weight of a coke powder having an average particle diameter of 5 μm, 20 parts by weight of tar pitch, 7 parts by weight of silicon carbide having an average particle diameter of 48 μm, and 10 parts by weight of coal tar were mixed first, and mixed at 200° C. for 1 hour. The resulting mixture was pulverized, pressed into pellets, and subsequently calcined at 3000° C. in a nitrogen atmosphere. The resulting calcined material was pulverized with a hammer mill, yielding a core made of fine graphite. The particle size distribution of the graphite core was measured with a particle size distribution analyzer and it was found that the particle diameter at a frequency of 50% (median diameter, D₅₀) was 20 μm or less. By varying the time and the number of classification, a core having a D₅₀ of 20 μm and a core having a D₅₀ of 2 μm were prepared.

The coke powder used is not limited to the above-described conditions and a material having an average particle diameter within a range of from 1 μm to several tens μm may be chosen. The composition of the coke powder and the tar pitch may be changed appropriately. Other conditions such as heat treatment temperature are not limited to the above-described contents. Natural graphite may be used instead of the above-mentioned artificial graphite.

On the surface of the above-described core, a coating layer made of carbon was formed in the following procedures. First, a mixed solution of a graphite core and a phenol resin was prepared by immersing and dispersing 100 parts by weight of the resulting graphite core in 160 parts by weight of a methanol solution of a novolac type phenol resin (produced by Hitachi Chemical Co., Ltd). This solution was successively subjected to filtration, drying, and heat treatment within the range of 200° C. to 1000° C., so that graphite particles the surface of the cores of which had been coated with carbon were obtained.

In the Examples and the Comparative Examples, the average thickness of the coating layer made of low crystalline carbon was adjusted to 20 nm, but it is adjustable within the range of 1 to 200 nm.

A negative electrode active material was prepared by mixing the graphite particles and metal-containing particles capable of occluding and emitting lithium ions as provided below, followed by the production of a negative electrode. The specification of the negative electrode active material in each of the Examples and the Comparative Examples is given in Table 1.

In the column of the surface treatment of metal-containing particles of Table 1, the presence or absence of surface treatment of silicon particles, which are metal-containing particles and the composition of a surface when surface treatment was carried out are shown. In the column of metal composition of Table 1, the amount of the metal (silicon) contained in metal-containing particles is shown in weight percentage on the basis of the weight of the metal-containing particles.

The addition ratios of the metal-containing particles and the graphite particles shown in Table 1 represent the addition ratios (weight ratios) of the metal-containing particles and the graphite particles relative to the entire weight of the negative electrode active material weight except the binder assigned as 1. The entire weight of the negative electrode active material weight except the binder as referred to herein is the Overall weight combining the metal-containing particles, the graphite particles and, when adding, the carbon fibers or the carbon nanotubes and/or the carbon black.

In each Example and Comparative Example, silicon was chosen as the metal of metal-containing particles.

The metal-containing particles in Example 1 are silicon fine powders the surface of which is coated with carbon. First, an ingot of silicon was pulverized and classified in an inert gas atmosphere, obtaining fine powders having an average particle diameter of 100 nm. A commercially available pulverizer such as a ball mill and a jet mizer was used for the pulverization of silicon. An organic substance such as phenol and polyvinyl alcohol was added thereto and then carbonized, thereby preparing metal-containing particles coated with carbon. The silicon particles having an average particle diameter of 100 nm were converted into secondary particles each composed of a plurality of particles having a surface coated with carbon, and powders having an average particle diameter of 2 μm obtained by classifying the secondary particles were used as the metal-containing particles of Example 1. In other Examples and Comparative Examples, metal-containing particles having different average particle diameters can be obtained by altering the classification time and the number of classifications.

The metal-containing particles (silicon particles) of Example 2, Example 4, Example 5, and Example 9 were particles obtained by finely dividing silicon in an inert gas atmosphere as described above.

The metal-containing particles (silicon particles) of Example 3, Example 6, Example 7, and Example 8 were particles produced by forcefully vaporizing silicon by arc melting in an inert gas atmosphere of nitrogen.

The metal-containing particles in Example 10 are particles prepared by forming a nitride on the surface of silicon particles. Specifically, the silicon particles in Example 1 were subjected to heat treatment at 1400° C. in a nitrogen gas atmosphere, forming a coating of silicon-nitrogen on the silicon surface. The metal composition in the metal-containing particles was 99% by weight and the nitrogen composition was 1% by weight. Such metal-containing particles were added in the same weight ratio (addition ratio=0.5) as graphite particles.

Examples 11, 12, and 13 are examples in which carbon fibers or carbon nanotubes (CNT) were added.

Examples 11 and 12 are examples in which graphitized carbon fibers having a diameter of 0.1 μm and a length of 4 μm was further added to the mixture of metal-containing particles and graphite particles in Example 10 (differing in average particle diameter) The carbon fibers to be added were prepared by pulverizing carbon fibers 10 μm in length with a ball mill and adjusting the average length to 4 μm with an air flow classifier. The reason why the length was adjusted to 4 μm is that the carbon fibers are intended to link graphite particles by bringing it into contact with the surface of the two particles because the average particle diameter of the graphite particles was 2 μm. This allows electrons to easily flow between two graphite particles. The reason why the length is prevented from being greater than 4 μm is that a fiber being longer than the length corresponding to two graphite particles comes into contact with a third graphite particle and therefore may lower the filling factor in the negative electrode. The addition amount of the carbon fibers was adjusted to 1% by weight relative to the overall weight of the metal-containing particles, the graphite particles, and the carbon fibers. Since the metal-containing particles and the graphite particles were mixed in the same weight, the addition ratios of the metal-containing particles and the graphite particles in Table 1 are written as 0.495, which is the value excluding the weight of the carbon fibers.

Example 13 is an example in which carbon nanotubes having a multiwall carbon network structure were further added to the mixture of metal-containing particles and graphite particles in Example 10 (differing in average particle diameter) The carbon nanotubes to be added were adjusted to 10 to 20 nm in diameter and 0.5 to 1 μm in length. The addition amount of the carbon nanotubes was adjusted to 1% by weight relative to the overall weight of the metal-containing particles, the graphite particles, and the carbon nanotubes.

The metal-containing particles in Example 14 are particles not only the surface but also the inside of which is made of silicon nitride (Si₃N₄). The metal-containing particles are fine powders prepared by pulverizing coarse particles (the particle diameter ranging from 5 μm to 10 μm) of silicon nitride (Si₃N₄) with a ball mill into an average particle diameter of 0.5 μm.

The metal-containing in Example 15 are made of a material prepared by producing silicon particles having an average particle diameter of 0.2 μm and then leaving them at rest in the air, thereby forming an oxide layer on the surface thereof.

The metal-containing particles in Example 16 are made of a material prepared by producing silicon particles having an average particle diameter of 0.2 μm and then depositing nickel on the surface of the silicon particles. The metal-containing particle in Example 17 is an example of having changed the aforementioned nickel to iron.

The metal-containing particles in Comparative Example 1 are particles obtained by preparing carbon-coated silicon particles by pulverization by the method of Example 1 and regulating the particle diameter with an air flow classifier into an average particle diameter of 4 μm.

In Comparative Example 2, there was used as a negative electrode active material not a mixture of graphite particles and metal-containing particles but a material prepared by attaching silicon fine particles (average particle diameter: 2 μm) to the surface of graphite (average particle diameter: 20 μm) by using a mechanofusion apparatus (manufactured by Hosokawa Micron Corp., AMS-MINI). It differs from the negative electrode active material of Example 1 in that silicon particles are attached uniformly to the entire surface of graphite particles.

A binder was mixed to the above-described graphite particles and metal-containing particles (and further carbon fibers or carbon nanotubes in some cases). PVDF was used as the binder, 1-methyl-2-pyrrolidone was added during the mixing, and thereby a pasty kneaded material was prepared. The addition amount of the binder was adjusted to 8% by weight relative to 92% by weight of the negative electrode active material. A planetary mixer was used for the kneading.

Then, the aforementioned kneaded material was applied, on a current collector. A 10 μm thick rolled copper foil was used as the current collector and the kneaded material was applied once to the copper foil by a doctor blade method.

Then, the applied material was put into a vacuum dryer and 1-methyl-2-pyrrolidone was thoroughly removed at 80° C. Subsequently, the material was compressed with a roll press, forming a negative electrode. The density of the negative electrode active material layer was adjusted to 1.5 g/cm³.

The area ratio shown in Table 1 represents the ratio of the area of metal-containing particles occupying the surface of a negative electrode to the area of graphite particles (the area of the metal-containing particles/the area of the graphite particles) detected when the surface of the negative electrode is observed. If each type of particles are uniformly distributed over the entire negative electrode, the area ratio in the surface almost agrees with the area ratio in a cross section taken by cutting the negative electrode along the plane direction at an arbitrary depth. In this Example, the surface of the negative electrode was photographed with a scanning electron microscope, the area of the metal-containing particles and the area of the graphite particles were determined by image processing, and then an area ratio was calculated from these values. Metal-containing particles and graphite particles can be distinguished by identifying the metal-containing particles by energy dispersive X-ray spectroscopy.

Using the positive electrode and the negative electrode prepared, a lithium secondary battery shown in FIG. 1 was produced. As an electrolytic solution, there was Used a solution prepared by dissolving 1 molar concentration (1 M=1 mol/dm³) of LiPF₆ in a mixed solvent of ethylene carbonate (abbreviated as EC) and ethylmethyl carbonate (abbreviated as EMC). The mixing ratio of EC and EMC was adjusted to 1:2 in volume ratio. Moreover, vinylene carbonate in an amount of 1% relative to the volume of the electrolytic solution was added to the electrolytic solution.

The rated capacity (calculated value) of the lithium secondary battery produced in each of the Examples and the Comparative Example is 3.5 Ah. For each of the Examples and the Comparative Examples, five lithium secondary batteries were prepared.

Initial aging treatment was performed for these lithium secondary batteries. First, charge was started from an open circuit state. The electric current was adjusted to 3.5 A and when the voltage reached 4.2V, this voltage was maintained. Then, charge was continued until the electric current became 0.1 A. Thereafter, a relaxation time of 30 minutes was provided and then discharge at 3.5 A was started. When the battery voltage reached 3.0 V, the discharge was stopped and the battery was idled for 30 minutes. Similarly, charge and discharge were repeated 5 times and then the initial aging treatment of the lithium secondary battery was terminated. An initial capacity was calculated by dividing the discharge capacity of the last cycle (the fifth cycle) by the weight (10±0.1 g) of the negative electrode active material. The results are shown in the column of initial capacity of Table 1.

Then, all the lithium secondary batteries resulting from the initial aging were subjected to a cycle test under the same charge-discharge conditions as the initial aging at an environmental temperature of 25° C. The average of the capacity retention after lapse of 100 cycles is shown in Table 1. For all the lithium secondary batteries of Examples 1 to 17, the capacity retention exceeded 90%.

TABLE 1
Configurations of negative electrode active materials and cell evaluation results

| | Metal-containing particle | | | | | | | | |
|---|---|---|---|---|---|---|---|---|---|
| | | | Metal | | Graphite particle | | | Initial | Capacity |
| | Surface | D₅₀ | composition | Addition | D₅₀ | Addition | Area | capacity | retention |
| Test | treatment | (μm) | (wt. %) | ratio | (μm) | ratio | ratio | (mAh/g) | (%) |
| Example 1 | Carbon | 2 | 95 | 0.5 | 20 | 0.5 | 10 | 1850 | 90 |
| Example 2 | None | 0.1 | 100 | 0.5 | 20 | 0.5 | 200 | 1940 | 91 |
| Example 3 | None | 0.01 | 100 | 0.5 | 20 | 0.5 | 2000 | 1940 | 92 |
| Example 4 | None | 0.1 | 100 | 0.3 | 20 | 0.7 | 86 | 1290 | 93 |
| Example 5 | None | 0.1 | 100 | 0.1 | 20 | 0.9 | 22 | 640 | 93 |
| Example 6 | None | 0.01 | 100 | 0.5 | 2 | 0.5 | 200 | 1940 | 93 |
| Example 7 | None | 0.01 | 100 | 0.3 | 2 | 0.7 | 86 | 1290 | 94 |
| Example 8 | None | 0.01 | 100 | 0.1 | 2 | 0.9 | 22 | 640 | 95 |
| Example 9 | None | 0.1 | 100 | 0.05 | 20 | 0.95 | 11 | 470 | 93 |
| Example 10 | Nitride | 2 | 99 | 0.5 | 20 | 0.5 | 10 | 1970 | 95 |
| Example 11 | Nitride | 0.2 | 99 | 0.495 | 2 | 0.495 | 10 | 1940 | 96 |
| Example 12 | Nitride | 0.01 | 99 | 0.495 | 2 | 0.495 | 196 | 1940 | 97 |
| Example 13 | Nitride | 0.2 | 99 | 0.495 | 2 | 0.495 | 10 | 1940 | 97 |
| Example 14 | Nitride | 0.5 | 60 | 0.5 | 20 | 0.5 | 40 | 960 | 97 |
| | (entirety) | | | | | | | | |
| Example 15 | Si—O | 0.2 | 100 | 0.5 | 2 | 0.5 | 10 | 1960 | 94 |
| Example 16 | Si—Ni alloy | 0.2 | 99 | 0.5 | 2 | 0.5 | 10 | 1920 | 95 |
| Example 17 | Si—Fe alloy | 0.2 | 99 | 0.5 | 2 | 0.5 | 10 | 1920 | 94 |
| Comparative | Carbon | 4 | 95 | 0.5 | 20 | 0.5 | 5 | 1820 | 86 |
| Example 1 | | | | | | | | | |
| Comparative | None | 2 | 100 | 0.5 | 20 | 0.5 | 10 | 1730 | 75 |
| Example 2 | | | | | | | | | |

The results of Example 1 and Example 2 show that even though the addition ratio of metal-containing particles was the same, the initial capacity was slightly lowered in Example 1 since a coating layer of carbon was formed in Example 1. This result has shown that the initial capacity increases as the weight ratio of the metal in metal-containing particles, i.e., the amount of silicon, increases. In both Example 2 and Example 3, since the metal-containing particles were made of silicon alone, there was no difference in initial capacity. The capacity retention tends to increase as the average particle diameter of metal-containing particles becomes smaller and when the average particle diameter was changed from 2 μm (Example 1) to 0.01 μm (Example 3), the capacity retention increased 2%.

From the results of Example 2, Example 4, and Example 5, it has become clear that the initial capacity increases as the addition ratio of metal-containing particles becomes larger. Although the capacity retention seems to lower as the addition ratio of metal-containing particles gets more, no difference is observed between an addition ratio of 0.1 and that of 0.3.

Similarly, also when comparing Example 6, Example 7, and Example 8 in which the average particle diameters of metal-containing particles and graphite particles were made smaller, it has been found that the initial capacity increases but, conversely, the capacity retention lowers as the addition ratio of metal-containing particles gets greater.

According to Example 9, when the addition ratio of metal-containing particles decreased to 0.05 (5%), the initial capacity lowered considerably and approached the theoretical capacity of graphite (372 mAh/g). Therefore, it is believed that the lower limit of the addition ratio of metal-containing particles is present between 0.05 (Example 9) and 0.1 (Example 5).

When the surfaces of the negative electrodes in Examples 1 to 13 were observed with an electron microscope, metal-containing particles had been inserted into voids located between a graphite particle and another graphite particle. As to the negative electrode in Comparative Example 1, since the average particle diameter of metal-containing particles is excessively large, the number of contact points between a graphite particle and another graphite particle has decreased to about ½ of those of Example 1. In the negative electrode of Comparative Example 2, silicon particles were inserted into not only voids located between a graphite particle and another graphite particle but also a face on which graphite particles are in contact with each other, and the number of points where graphite particles are in contact directly has been decreased.

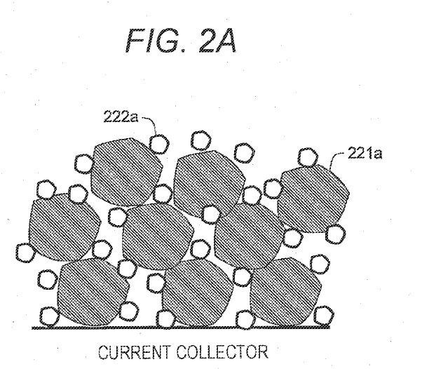

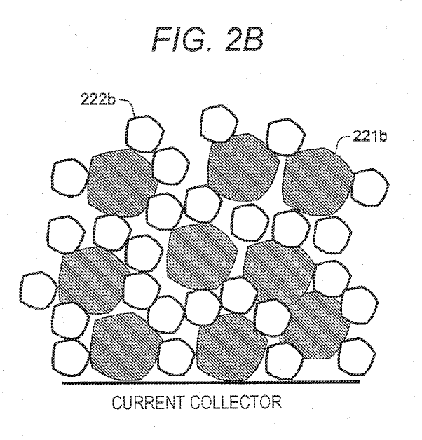

Comparing Example 1 and Comparative Example 1, these differ in the average particle diameter of metal-containing particles. In other words, the average particle diameter ratio of the metal-containing particles to the graphite particles differs. Specifically, the ratio of the average particle diameter of metal-containing particles to that of graphite particles is 1/10 in Comparative Example 1, whereas the ratio is ⅕ in Comparative Example 1. The influence of the difference is shown schematically in FIG. 2A and FIG. 2B. In Example 1, graphite particles 221a are in firm contact with each other as depicted in FIG. 2A and a skeleton of linked graphite particles 221a has been formed. Metal-containing particles 222a are stored in gaps between graphite particles 221a.

Specifically, metal-containing particles expanded during charge are stored in voids between graphite particles, so that metal-containing particles are prevented from falling off, and there is induced an effect that the skeleton of the graphite particles maintains the electrical conductivity of the entire negative electrode. As a result, a high capacity is achieved and a cycle lifetime is improved.

Such an effect is obtained not only by relaxing the expansion of the metal-containing particles by voids of graphite particles but also by holding the electronic conductivity of the entire negative electrode by linking the graphite particles. Therefore, the effect of the present invention cannot be obtained only from metal-containing particles.

Even if metal-containing particles and graphite particles are not mixed and the metal-containing particles are coated with an electrically conductive material such as graphite, the electrically conductive material on the exterior surface will exfoliate or decay from the change in volume of the metal-containing particles. Moreover, there are no graphite particles that electrically connect the entire negative electrode. As a result, with progress of a charge-discharge cycle, an electrolytic solution undergoes reductive decomposition on a newly exposed surface of the metal-containing particles, so that the metal-containing particles are deactivated, the electrical conductivity of the entire negative electrode is also lowered, and the lifetime of the negative electrode is shortened.

In Comparative Example 1, since the metal-containing particles 222b are excessively large as shown in FIG. 2B, the packing density of graphite particles 221b is lowered and the aforementioned skeleton decays. According to the configuration of Comparative Example 1, since there are not enough voids of graphite particles, graphite particles will gradually go away from each other, so that the electrical conductivity will deteriorate and the cycle lifetime will eventually be shortened. There has been developed a difference in the effect of the present invention from Comparative Example 1 in that the particle size ratio of the negative electrode active material of Comparative Example 1 is ⅕ and does not fulfill the particle Size ratio of 1/10, which is one requirement of the present invention.

By using metal-containing particles and graphite particles at the same time, change in volume of the metal-containing particles can be eased and a long-life negative electrode is provided. Considering from the viewpoint of the area ratio of metal-containing particles, comparison of the results of Examples 1 to 17 and Comparative Example 1 shows that a long-life negative electrode can be obtained by adjusting the ratio of the area of metal-containing particles to the area of graphite particles to 10 to 2000. Especially, negative electrodes having the longest lifetime were obtained in Examples 4 to 13. Therefore, it has become clear that it is more desirable to adjust the ratio of the area of metal-containing particles to the area of graphite particles to 10 to 200.

That is, when the particle size ratio of metal-containing particles to graphite particles is adjusted to 1/2000 to 1/10 as in the present invention and the ratio of the area of the metal-containing particles and the area of the graphite particles occupying the surface or a cross section is adjusted to 10 to 2000, the packing density of the graphite particles 221a increases, so that there is produced an effect that the graphite particles 221a keep the structure of the entire negative electrode. When the area ratio is adjusted to 10 to 200, a negative electrode having a further elongated lifetime is formed.

In Comparative Example 2, since silicon particles are attached uniformly to an almost entire surface of graphite particles and silicon, particles are located at places other than the voids of graphite particles, intervals between graphite particles are gradually elongated from the Change in volume of silicon, so that electronic resistance will increase. Accordingly, the initial capacity and the capacity retention became worse than Example 1. On the other hand, in the present invention, metal-containing particles expanded during charge are accommodated in voids between graphite particles and the electron conductivity of the entire negative electrode is held by connection of the graphite particles. Accordingly, a high-capacity, long-life negative electrode can be obtained not by arranging silicon uniformly on the entire surface of graphite particles but by mixing silicon with graphite particles and arranging the silicon selectively in voids between the graphite particles.

Therefore, it was found that even if the average particle diameter ratio or the area ratio fulfills the condition of the present invention, a long-life negative electrode active material cannot be obtained unless metal-containing particles and graphite particles have been added individually and mixed.

Example 10 is an example in which a nitride layer that inhibits a reaction with an electrolytic solution was formed on the surface of particles containing metal. As compared with Example 1, in which untreated metal-containing particles were used, the initial capacity was the same, but the capacity retention was improved 5%.

In Example 11 and Example 12, carbon fibers were added. As compared with corresponding Example 1 and Example 6, the initial capacity was lowered slightly, but the capacity retention was improved. This is presumably because the carbon fibers further strengthened the skeleton of graphite particles as schematically shown in FIG. 2A.

Example 13 is an example in which carbon nanotubes were added, and as a result of a test, the electrical conductivity in the negative electrode can be increased in a smaller amount than a case of mixing carbon fibers. As a result, it has become clear that the initial capacity is improved and the capacity retention is also increased.

Example 14 has shown that if the weight ratio of metal in particles containing the metal is 60% or more, a negative electrode that is high in capacity retention can be obtained.

The results of Example 1, Example 10, and Examples 15 to 17 made it clear that the capacity retention is increased by forming carbon, a nitride, an oxide, nickel, or iron on a silicon surface as particles containing metal. These surface layers are believed to have inhibited a reaction between metal and an electrolytic solution and thus have developed a function to inhibit the decrease in capacity of a negative electrode.

### Example 18

Next, a battery module shown in FIG. 3 was constituted using the lithium secondary battery in Example 13 and then a charge/discharge test was conducted. The external power source 311 of FIG. 3 was tested after being replaced by an apparatus for supplying electricity and loading.

In a charge test just after assembling of the battery system, a charge current corresponding to 1 hour rate current Value (3.5 A) was fed from the charge and discharge circuit 310 to the positive electrode external terminal 307 and the negative electrode external terminal 308. Thus, a 1-hour charge was performed at a constant voltage of 33.6 V. The constant voltage value set here is 8 times 4.2 V, which is the constant voltage value of the lithium secondary battery 302. The power that is needed for the charge and discharge of the battery module was supplied from the apparatus for supplying electricity and loading.

In a discharge test, a reverse current was made to flow from the positive electrode external terminal 307 and the negative electrode external terminal 308 to the charge and discharge circuit 310, and power was consumed in the apparatus for supplying electricity and loading. The discharge current was set to a condition of 1 hour rate (discharge current was 3.5 A), and the discharge was performed until the inter-terminal voltage between the positive electrode external terminal 307 and the negative electrode external terminal 308 reached 24 V.

Under such charge and discharge test conditions, there was obtained an initial performance in which the charge capacity was 3.5 Ah and the discharge capacity was 3.4 Ah to 3.5 Ah. Furthermore, a charge and discharge cycle test of 300 cycles was performed, and a capacity retention ratio of 94% to 95% was obtained.

### Example 19

Next, a test was carried out using the battery system shown in FIG. 4. The external device 419 was supplied with electric power during charge and was made to consume electric power during discharge. In this Example, the batteries were charged at 2 hour rate and were discharged at 1 hour rate. Thus, an initial discharge capacity was determined. As a result, there were obtained capacities as large as 99.1% to 99.6% of the designed capacity 3.5 Ah of the battery modules 401a and 401b.

Then, a charge-discharge cycle test described below was performed under the condition represented by an environmental temperature of 20° C. to 30° C. First, the batteries were charged with a current at 2 hour rate (1.75 A). When the state of charge had reached 50% (the state of being charged to 1.75 Ah), a 5 second pulse in the charge direction and a 5 second pulse in the discharge direction were given to the battery modules 401a, 401b, whereby there was conducted a pulse test simulating power reception from the power generator 422 and the power supply to the external device 419. The magnitudes of both of the current pulses were set to 150 A. Successively, the remaining capacity 1.75 Ah was charged with a current at 2 hour rate (1.75 A) until the voltage of each of the batteries reached 4.2 V. A constant voltage charge was continued at that voltage for one hour, and then the charge was terminated. Then, discharge was performed with a current at 1 hour rate (3.5 A) until the Voltage of each of the batteries reached 3.0 V. Such a series of charge-discharge cycle test was repeated 500 times. As a result, capacities as high as 88 to 89% of the initial discharge capacity were obtained. It was found that the performance of a battery system is hardly lowered even if current pulses of power reception and power supply were given to battery modules.

The present invention is not limited to the embodiments described above and includes various modifications. For example, a part of the configuration of each embodiment may be added; deleted, or replaced by a different configuration.

All publications, patents, and patent applications cited herein are incorporated herein by reference in their entirety.

### REFERENCE SIGNS LIST

101 lithium secondary battery
110 positive electrode
111 separator
112 negative electrode
113 battery can
114 positive electrode current collection tab
115 negative electrode current collection tab
116 inner lid
117 internal pressure release valve
118 gasket
119 positive temperature coefficient (PCT) resistive element
120 battery lid
221a graphite particle
222a metal-containing particle
221b graphite particle
222b metal-containing particle
301 battery module
302 lithium secondary battery
303 positive electrode terminal
304 bus bar
305 battery can
306 hold component
307 positive electrode external terminal
308 negative electrode external terminal
309 calculation unit
310 charge and discharge circuit
311 external power source
312 power line
313 signal line
314 external power cable
401a battery module
401b battery module
407 negative electrode external terminal
408 positive electrode external terminal
413 power cable
414 power cable
415 power cable
416 charge/discharge controller
417 power cable
418 power cable
419 external device
420 power cable
421 power cable
422 power generator

1. A negative electrode active material for a lithium secondary battery, the negative electrode active material being composed of a mixture of graphite particles capable of occluding and emitting lithium ions and particles containing metal, wherein the particles containing metal have, on their surfaces, a layer comprising one or more kinds of elements selected from the group consisting of carbon, nitrogen, and oxygen, the average particle diameter of the particles containing metal during discharge is 1/2000 to 1/10 of that of the graphite particles, the graphite particles have an average particle diameter during discharge of 2 μm to 20 μm, and the addition ratio by weight of the particles containing metal is 10% to 50%.

2. The negative electrode active material for a lithium secondary battery according to claim 1, wherein the weight ratio of the metal in the particles containing metal is 60% to 100%.

3. (canceled)

4. The negative electrode active material for a lithium secondary battery according to claim 2, further comprising carbon fibers having a length equal to or smaller than twice the average particle diameter of the graphite particles, wherein the content of the carbon fibers is 1% by weight to 5% by weight of the weight of the negative electrode active material.

5. The negative electrode active material for a lithium secondary battery according to claim 4, further comprising carbon nanotubes and/or carbon black, wherein the content of the carbon nanotubes and/or the carbon black is 1% by weight to 2% by weight of the weight of the negative electrode active material.

6. A lithium secondary battery comprising a negative electrode containing the negative electrode active material according to claim 5, a positive electrode, and an electrolyte, wherein the ratio of the area of the particles containing metal to the area of the graphite particles occupying the surface or a cross section of the negative electrode is 10 to 2000 in a discharged state.
